(19) United States
(12) Patent Application Publication
(10) Pub. No.: US 2023/0375324 A1
(43) Pub. Date: Nov. 23, 2023

(54) METHOD FOR DETERMINING A LINE LENGTH

(71) Applicant: Vitesco Technologies GmbH, Regensburg (DE)

(72) Inventors: Tobias LUEBBERT, Köln (DE); Peter BAUER, Bonn (DE); Cornelius KÖHLER, Hürth (DE); Youness IDAR, Freyming-Merlebach (FR)

(21) Appl. No.: 18/031,197

(22) PCT Filed: Oct. 4, 2021
(86) PCT No.: PCT/EP2021/077213

§ 371 Date: Apr. 11, 2023

(30) Foreign Application Priority Data
Oct. 12, 2020 (DE) 10 2020 212 849.9

(51) Int. Cl. G01B 7/02; F16L 53/38; H05B 3/58; H05B 1/02

(52) U.S. Cl. CPC G01B 7/026; F16L 53/38; H05B 3/58; H05B 1/0236

(57) ABSTRACT

A method for determining the length of a heated pressure line for a conveying device for an aqueous urea solution in a motor vehicle from a tank to an injector, wherein the pressure line is electrically heatable and is heated, using ohmic resistance, by the application of a voltage to an electrical conductor led on the pressure line, wherein the length of the pressure line is calculated by the following formula:

$${l}_{pressure line} = \frac{{R}_{heating conductor} \times A}{ρ}$$

where A designates the cross section of the electrical conductor and p the specific electrical resistance of the electrical conductor and R_{heating conductor} the electrical resistance of the electrical conductor used to heat the pressure line.

### CROSS REFERENCE TO RELATED APPLICATIONS

This is a U.S. national stage of Application No. PCT/EP2021/077213 filed Oct. 4, 2021. Priority is claimed on German Application No. DE 10 2020 212 849.9 filed Oct. 12, 2020 the content of which is incorporated herein by reference.

### BACKGROUND OF THE INVENTION

### 1. Field of the Invention

The disclosure relates to a method for determining the length of a heated pressure line for a conveying device for an aqueous urea solution in a motor vehicle from a tank to an injector, wherein the pressure line is electrically heatable and is heated, using ohmic resistance, by the application of a voltage to an electrical conductor led on the pressure line.

### 2. Description of Related Art

In many countries all around the world, legal regulations have been made that define an upper limiting value for the content of specific substances in the exhaust gas from internal combustion engines. These are mostly substances of which the discharge into the environment is undesirable. One of these substances is represented by nitrogen oxide (NOx), of which the proportion in the exhaust gas must not exceed legally defined limiting values. Because of the boundary conditions, for example the design of the internal combustion engines with a view to beneficial consumption and the like, the internal engine avoidance of the nitrogen oxide emissions when reducing the proportion of the nitrogen oxides in the exhaust gas is possible only to a limited extent, so that exhaust gas post-treatment is necessary to comply with relatively low limiting values. Here, it has transpired that selective catalytic reduction (SCR) of the nitrogen oxides is advantageous. This SCR method needs a reducing agent which contains nitrogen. In particular, the use of ammonia (NH₃) as a reducing agent has emerged as a possible alternative. Because of the chemical properties and the legal provisions in many countries, the ammonia is usually not kept as pure ammonia, since this can lead to problems in particular in motor vehicles or other mobile applications. Rather, instead of storing the reducing agents themselves, reducing-agent precursors are often stored and carried along. A reducing-agent precursor is to be understood in particular to mean a substance which splits off the reducing agent or which can be converted chemically into the reducing agent. For example, urea represents a reducing-agent precursor for the reducing agent ammonia.

The aqueous ammonia solution, the urea, is carried along in a tank and conveyed into the exhaust gas tract in accurately metered quantities by a suitable conveying device. For this purpose, the aqueous ammonia solution is guided along a pressure line from the conveying device to an injector. The aqueous urea solution is finally introduced into the exhaust gas tract by the injector and is thermally converted into ammonia and water there in order then to effect the reduction of the nitrogen oxides contained in the exhaust gas.

To ensure the functionality of the conveying device, in particular the flushing and filling of the lines, it is necessary for parameters, such as the number, the length and the diameter of the pressure lines, to be stored in the control device of the conveying device. Hitherto, these parameters have been entered manually into the control device which, firstly, represents a high burden in terms of time and costs and secondly represents a source of error.

### SUMMARY OF THE INVENTION

An object of one aspect of the present invention is, therefore, to devise a method which permits the parameters of the pressure lines necessary for the operation of the conveying device or of the pressure lines to be detected automatically and to be stored in the control device.

One aspect of the invention relates to a method for determining the length of a heated pressure line for a conveying device for an aqueous urea solution in a motor vehicle from a tank to an injector, wherein the pressure line is electrically heatable and is heated, using ohmic resistance, by the application of a voltage to an electrical conductor led on the pressure line, wherein the length of the pressure line is calculated by the following formula:

$${l}_{pressure line} = \frac{{R}_{heating conductor} \times A}{ρ}$$

where A designates the cross section of the electrical conductor and p the specific electrical resistance of the electrical conductor and R_{heating conductor} the electrical resistance of the electrical conductor used to heat the pressure line.

The fluid is conducted from the tank to the injector by flowing through the following elements. From the tank through a connection element, for example a connector, through the actual pressure line, through a further connection element, for example a connector, to the injector, by which the fluid is finally introduced into the exhaust gas tract.

One important variable to ensure fault-free operation of the conveying device is the length of the pressure line. This is important in order, for example, to be able to correctly carry out the flushing of the pressure line and also the forward conveyance of fluid into the pressure line. As a result of a change in the length of the pressure line, the flushing time or the forward conveyance time would no longer be adequate or be too long. Exact matching to the pressure line actually used is thus necessary.

The approach followed here is based on the fact that, firstly, the properties associated with the material of the electrical conductor, such as the specific electrical resistance and the cross section, are known and, secondly, the power consumption of the electrical conductor functioning as a heater is known. Thus, the length of the pressure line can be calculated by working back from the known power consumption.

It is particularly advantageous if the electrical resistance Rheating conductor is given by the formula

R_{heating conductor}=Rₜₒₜₐₗ−(R_{connector 1}+R_{connector 2})

where Rₜₒₜₐₗ corresponds to the total electrical resistance of the heating conductor used for heating the pressure line and the electrical resistance of the electrically heatable connectors used on the pressure line.

The electrical resistance of the electrical conductor which is used for heating the pressure line results from the total resistance of the heating device as a whole, that is to say the electrical conductor on the pressure line and the connectors, minus the electrical resistances of the two heatable connectors used.

It is also advantageous if the total electrical resistance Rₜₒₜₐₗ is given by the ratio of the applied voltage U to the current intensity I, wherein the power P used for the heating is given by multiplying the applied voltage U and the current intensity I.

With a known power consumption P, with a known current intensity or voltage, the voltage regularly being defined by the existing electrical installation of the motor vehicle and therefore being known, the total resistance of the heating device can thus be determined.

A preferred exemplary aspect of the invention is characterized in that the pressure line is coated with an electrically conductive material, which forms the electrical conductor. The pressure line is preferably made of a flexible material such as, for example, a plastic, which additionally has a sufficiently high bursting strength. Such a plastic line can be covered, wholly or partly, with a metallic electrically conductive layer. This layer then forms the heating element.

It is also to be preferred if the determination of the length of the pressure line is carried out a first time after the final installation has been carried out, wherein the determined value is stored in a non-rewritable memory of the conveying device.

The final installation can be defined, for example, by the final installation in the vehicle. In any case, this means a time after which no structural change to the system, such as for example the replacement of parts, is envisaged. The conveying device and in particular the pressure line are in an installed state, which also corresponds to the state during the later planned use.

By the determination of the line length according to the method of one aspect of the invention, a value is determined which is unchangeably stored in a memory of the conveying device. The determined line length is then firstly used to be able to correctly depict the other relevant functions of the conveying device, such as the flushing and forward conveyance, and, for example, to be able to set the conveying time of the fluid pump as exactly as possible. Secondly, the determined line length is stored as a reference value in order to be able to detect a change to the overall system, for example as a result of replacement of the pressure line.

To this end, it is advantageous if the method is carried out repeatedly at defined times during the period of use of the motor vehicle and a comparison is made with the value stored in the non-rewritable memory.

As a result of the repeated execution of the method, for example when the engine is started or at another defined time, in each case a current value for the length of the pressure line is again determined. Thus, a change in the system can be detected by a comparison with the originally determined and stored value.

Apart from a change in the length of the pressure line, a change in the electrical resistance can also be detected in this way, and thus a defect, for example as a result of a broken electrical conductor, can be detected.

Furthermore, it is advantageous if, in the event of determining that there is a deviation between the value stored in the non-rewritable memory and the newly determined value, an error message is generated. An error message can trigger a display in the field of view of the driver, so that the latter is informed about a detected irregularity. Furthermore, it is advantageous if the error message is stored in a memory of the conveying device or of the motor vehicle in order to use this for diagnostic purposes.

It is also expedient if the pressure line is formed from an electrically conductive material, the pressure line itself forming the electrical conductor for heating.

Alternatively, for example, an electrical conductor can be wound around the pressure line. In any case, the electrical conductor, whether as a coating, as a fluid-carrying component itself or as a wound conductor, is no longer changeable following the final installation of the system, so that the electrical conductor and thus the electrical resistance produced by the conductor is constant.

Furthermore, it is advantageous if the pressure line is attached to the tank in a fluid-conducting manner at a free end via a first connector and, at the second free end, is attached to the injector in a fluid-conducting manner by a second connector.

Connectors are components that are used for the pressure-safe connection of two components. Inter alia, there are also connectors which themselves are electrically heatable. These have an electrical conductor surrounding the fluid channel, through which a current can be passed, in order thus to achieve heating of the connector. Each of the heatable connectors used thus also has an individual electrical resistance, which must be factored out to determine the exact length of the pressure line via the method according to one aspect of the invention.

It is also advantageous if the control device in the conveying device is already written with a specific dataset, wherein the latter is completed by the value for the length of the pressure line that is determined following the final installation. Manual data entry to the control device can thus be dispensed with and the control devices of different motor vehicles could be provided with a uniform dataset, which is matched to the respective specific boundary conditions on the basis of the method according to the invention. In this way, inter alia, a source of error is also ruled out since a dataset with a false value for the line length cannot be used through oversight. This increases the robustness of the system.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-9. (canceled)

10. A method for determining a length of a heated pressure line for a conveying device for an aqueous urea solution in a motor vehicle from a tank to an injector,
wherein the heated pressure line is electrically heatable and is heated, using ohmic resistance, by application of a voltage to an electrical conductor led on the heated pressure line, comprising:
calculating the length of the heated pressure line by:
$${l}_{pressure line} = \frac{{R}_{heating conductor} \times A}{ρ}$$
wherein:
A designates a cross section of the electrical conductor;
ρ is a specific electrical resistance of the electrical conductor; and
R_{heating conductor} is an electrical resistance of the electrical conductor used to heat the heated pressure line.

11. The method as claimed in claim 10, wherein the electrical resistance R_{heating conductor} is given by:
R_{heating conductor}=Rₜₒₜₐₗ−(R_{connector 1}+R_{connector 2})
Wherein:
Rₜₒₜₐₗ corresponds to a total electrical resistance of a heating conductor configured to heat the heated pressure line and the electrical resistance of electrically heatable connectors used on the heated pressure line.

12. The method as claimed in claim 11, wherein the total electrical resistance Rtotal is given by a ratio of an applied voltage U to a current intensity I, wherein a power P used for heating is given by multiplying the applied voltage U and the current intensity I.

13. The method as claimed in claim 10, wherein the heated pressure line is coated with an electrically conductive material, which forms the electrical conductor.

14. The method as claimed in claim 10, wherein a determination of the length of the heated pressure line is carried out a first time after a final mounting has been carried out, wherein the determined value is stored in a non-rewritable memory of the conveying device.

15. The method as claimed in claim 14, wherein the method is carried out repeatedly at defined times during a period of use of the motor vehicle and a comparison is made with the value stored in the non-rewritable memory.

16. The method as claimed in claim 15, wherein upon determining that there is a deviation between the value stored in the non-rewritable memory and a newly determined value, an error message is generated.

17. The method as claimed in claim 10, wherein the heated pressure line is formed from an electrically conductive material, the heted pressure line itself forming an electrical conductor for heating.

18. The method as claimed in claim 10, wherein the pressure line is attached to the tank in a fluid-conducting manner at a free end via a first connector and, at the second free end, is attached to the injector in a fluid-conducting manner by a second connector.
